(19) United States
(12) Patent Application Publication
(10) Pub. No.: US 2013/0194827 A1
(43) Pub. Date: Aug. 1, 2013

(54) SWITCHING POWER SUPPLY

(71) Applicant: Fuji Electric Co., Ltd., Kawasaki-shi (JP)

(72) Inventor: Jian CHEN, Matsumoto-city (JP)

(73) Assignee: FUJI ELECTRIC CO., LTD., Kawasaki-shi (JP)

(21) Appl. No.: 13/711,797

(22) Filed: Dec. 12, 2012

(30) Foreign Application Priority Data
Jan. 26, 2012 (JP) 2012-013710

(51) Int. Cl. H02M 3/335

(52) U.S. Cl. CPC H02M 3/33507
USPC 363/16

(57) ABSTRACT

A switching power supply of certain aspects of the invention includes a minimum dead time generating circuit that generates a minimum dead time from an OFF timing of an ON pulse detected from the voltage across an auxiliary winding of the transformer by a differentiating circuit. An ON width-determining means of a voltage control oscillator is started, after this minimum dead time, into operation to determine the ON width of the semiconductor switch.

### BACKGROUND OF THE INVENTION

1. Field of the Invention

Embodiments of the invention relate to switching power supplies of a current resonance type, and in particular to switching frequency stabilization of switching power supplies.

2. Description of the Related Art

FIG. 4 shows a circuit diagram of a conventional resonance type switching power supply. The switching power supply comprises a transformer T having a primary winding WP1 and secondary windings WS1 and WS2 with a center tap therebetween in the main circuit of the switching power supply. The switching power supply comprises, in the primary side thereof, a capacitor Ci that is a power supply having a positive terminal Pi and a negative terminal Ni, a series circuit of semiconductor switches of MOSFETs Qa and Qb connected in parallel to the capacitor Ci, and a series circuit of the primary winding WP1 and a resonant capacitor Cr connected in parallel to the MOSFET Qb. The switching power supply comprises, in the secondary side thereof, rectifying diodes D1 and D2 connected to the secondary windings WS1 and WS2, respectively, and a DC output capacitor Co that is supplied with a full-wave rectified voltage and has terminals connecting to DC output terminals Po and No. The resistor Ro connected in parallel with the capacitor Co is a dummy resistor for stabilizing the output voltage in a no load period.

The circuit for controlling the switching power supply comprises: an error amplifier GA that senses a DC output voltage Vo and amplifies the error from a reference voltage, a voltage controlling oscillator VCO that receives the output from the GA, a control circuit CNT2 connected to the output of the voltage control oscillator VCO, and a driving circuit GD that converts the output from the control circuit CNT2 to the driving signal for the MOSFETs Qa and Qb. The MOSFETs Qa and Qb of this switching power supply repeat turning ON and OFF alternately in a duty factor near 50% with a certain dead time in which the both MOSFETs are in an OFF state. Thus, current resonance operation is performed with a leakage inductance between the primary winding WP1 and the secondary windings WS1 and WS2 of the transformer T and the resonance capacitor Cr to transfer electric power from the primary side to the secondary side.

The output from the secondary winding of the transformer T is rectified by the diodes D1 and D2, and smoothed by the smoothing capacitor Co to become a DC output voltage with a small ripple. The output voltage is sensed by the error amplifier circuit GA; the voltage controlling oscillator circuit VCO controls the oscillation frequency based on the output voltage; and the control circuit CNT2 and the driving circuit GD generate the signals for ON-OFF controlling the two MOSFETs Qa and Qb alternately. Thus, stable output voltage is obtained. The switches Qa and Qb in the switching power supply repeat ON and OFF operation alternately in a duty factor near 50% with a certain dead time in which the both switches are in an OFF state. Thus, a current resonant operation is performed with a leakage inductance between the primary winding WP1 and the secondary windings WS1 and WS2 of the transformer T and the resonance capacitor Cr to transfer electric power from the primary side to the secondary side.

One of the advantages of the current resonance type switching power supply is implementation of soft switching using body diodes Da and Db of the MOSFETs Qa and Qb. From the state in which the high side MOSFET Qa is in an OFF state and the low side MOSFET Qb is in an ON state carrying the current IQb in the direction indicated by the arrow in FIG. 4, when the low side MOSFET Qb turns OFF, the current IQb is commutated to the body diode Da of the high side MOSFET Qa. When an electric current is flowing through the body diode Da, the voltage Vs at the connection point between the MOSFETs Qa and Qb is nearly equal to the voltage Vi of the capacitor Ci, which is a DC power supply. As a consequence, turning ON of the MOSFET Qa in this period does not change rapidly the voltage across the MOSFET Qa. Thus, zero voltage switching (ZVS) is performed.

Similarly, when the high side MOSFET Qa is turned OFF and the current IQa that has been flowing in the MOSFET Qa is commutated to the body diode Db of the low side MOSFET Qb, and the voltage Vs at the connection point of the MOSFETs Qa and Qb becomes nearly equal to the ground potential. As a consequence, turning ON of the MOSFET Qb, in this period of current-carrying state of the body diode Db, does not change rapidly the voltage across the MOSFET Qb. Thus, zero voltage switching (ZVS) is performed in this case, too.

However, when the voltage Vs at the connection point between the MOSFETs Qa and Qb is at a certain voltage between the voltage Vi of the capacitor Ci as a DC voltage source and the ground potential, if the MOSFET Qa or MOSFET Qb is turned ON, hard switching occurs. In this case, the current through the MOSFET Qa or MOSFET Qb as well as the voltage across the MOSFET Qa or MOSFET Qb changes rapidly. This generates noise and cause power loss in the MOSFET Qa or MOSFET Qb. In addition, in the time duration the body diode Da of the MOSFET Qa is carrying an electric current, if the MOSFET Qb turns ON, through-current flows during the reverse recovery time from the DC power source Ci through the body diode Da to the MOSFET Qb. This through-current can grow instantaneously to a large current and may break down the MOSFETs Qa and Qb.

Some measures have been proposed to cope with the problems of hard switching and the through-current. Japanese Unexamined Patent Application Publication No. 2005-051918 (also referred to herein as “Patent Document 1”), for example, discloses a switching power supply in which a state of current flow through the body diode is detected by sensing the current flowing in a resonant circuit and in this state, generation of a driving signal to turn ON or OFF of the two switches is inhibited. Japanese Unexamined Patent Application Publication No. 2006-527190 (also referred to herein as “Patent Document 2”) discloses a circuit and method that copes with both problems of hard switching and through-current by directly sensing the voltage at the connection point between the two switches.

However, the structure of Patent Document 1 necessarily includes a resistor for current sensing in the resonance circuit, which causes a power loss. The structure of Patent Document 2 needs to sense a high voltage at the connection point between the two MOSFETs, which requires a control circuit that has a high voltage element, so the structure needs a large scale control circuit.

To cope with the problems, the inventor of the present invention has proposed a circuit disclosed in Japanese Patent Application No. 2011-150974 (also referred to herein as “Patent Document 3”), the circuit generating a dead time based on voltage variation sensed by an auxiliary winding provided in the transformer. FIG. 5 shows the circuit construction of the switching power supply disclosed in Patent Document 3; FIG. 6 shows the circuit construction of the voltage control oscillator VCO2 in the circuit of FIG. 5; and FIG. 7 shows operation waveforms in the circuit of FIG. 5. The main circuit structure is similar to that of FIG. 4 except for the auxiliary winding WP2 added to the transformer T1. As shown in the circuit construction of FIG. 5, the auxiliary winding WP2 connects to a dv/dt detecting circuit DVD, the outputs P2_H and P2_L of the dv/dt detecting circuit DVD are delivered to a dead time adding circuit DT, and the output On_trig of the dead time adding circuit DT is delivered to a control circuit CNT3 and a voltage control oscillator VCO2.

FIG. 6 shows a circuit construction of the voltage control oscillator VCO2. Dead time widths, the Td1 and Td2 in FIG. 7, are determined by the circuit comprising a capacitor C2, a current source I2, a switch S2, a comparator CP2, and a reference voltage REF2. The width of the dead time is determined by the period from opening of the switch S2 at the turning OFF timing of the ON pulse until the voltage of the capacitor C2 reaches the reference voltage REF2.

The ON pulse width is determined by the integration circuit comprising a capacitor C1, a current source I1, and a switch S1. The capacitor C1 start to be charged when the dead time is passed after an On_trig is given. The ON pulse turns OFF when the voltage VC1 reaches the feedback voltage Vfb, which is the output of the error amplifier GA.

A switching frequency Fsw in the conventional current resonance type switching power supply of FIG. 4 is determined by an ON width Ton and a dead time Td determined in the voltage control oscillator VCO and given by the Formula (1) below.

Fsw=1/(2*(Ton+Td)) (1)

Here, the ON width Ton is determined by the feedback voltage Vfb and the dead time Td is determined by the control circuit to be a fixed value.

A dead time Td in the conventional current resonance type switching power supply having a dead time automatic adjusting function shown in FIG. 5 is determined by a dead time automatic adjusting circuit and referred to as a Tdadj.

Constant output voltage control uses voltage mode frequency control to perform stable operation. The ON width Ton is determined by the feedback voltage Vfb and given by the Formula (2) below.

Ton=fon(Vfb) (2)

The function fon(Vfb) is a linear or non-linear function. Therefore, the switching frequency Fsw is given by the Formula (3) below.

Fsw=1/(2*(fon(Vfb)+Tdadj)) (3)

As is apparent from the Formula (3), the switching frequency Fsw is a function of the feedback voltage Vfb and the dead time Tdadj.

As shown in FIG. 7, the voltage control oscillator VCO charges the capacitor of the integrating circuit after the end of the dead time. So, variation of the dead time causes variation in the switching frequency and oscillation of resonant current. Although the feedback voltage Vfb increases linearly in the beginning of the soft starting, due to lack of feedback control, variation of the dead time Tdadj may cause oscillation and generate acoustic noise. The variation in the Tdadj needs to be absorbed in the feedback control system in normal operation, so parameter setting for phase compensation is difficult resulting in occurrence of oscillation. Thus, there is a need for an improved switching power supply in the art.

### SUMMARY OF THE INVENTION

Embodiments of the invention address this and other needs. Embodiments of the invention provide a switching power supply of a resonance type in which the switching frequency does not change even though the dead time varies.

A switching power supply according to a first aspect of the present invention comprises: a transformer having a primary winding, a secondary winding, and a auxiliary winding, the auxiliary winding being disposed in a primary side of the transformer and detecting variation in a voltage across the primary winding; a series-connected circuit including a first semiconductor switch and a second semiconductor switch, the series connected circuit being connected in parallel to a DC power source; a series-connected resonance circuit including series-connected components of a resonance capacitor, an inductance element of at least one of a resonance reactor or a leakage inductance of the transformer, and the primary winding of the transformer; a differentiating circuit for detecting a timing of an inversion beginning timing or an inversion ending timing of the voltage detected by the auxiliary winding after receiving a first trigger signal for turning OFF of the first semiconductor switch or the second semiconductor switch; a dead time adjusting circuit for generating a second trigger signal at a timing of turn ON the first semiconductor switch or the second semiconductor switch delaying a predetermined time period from the timing detected by the differentiating circuit; and a voltage control oscillator including an ON width setting means that comprises a minimum dead time-generating circuit for generating a minimum dead time on receiving the first trigger signal and start up, after the minimum dead time, operation to determine an ON width of the first semiconductor switch or the second semiconductor switch.

A switching power supply according to a second aspect of the present invention is the switching power supply according to the first aspect of the invention, wherein the ON width determining means comprises: a minimum dead time-generating circuit for generating the minimum dead time on receiving the first trigger signal, an integration circuit to start integrating operation according to an output signal of the minimum dead time generating circuit, and a voltage comparing circuit for comparing the output of the integrating circuit with an output of an offset amplifier that senses a DC output voltage and nullify a difference from a reference value, and wherein the ON width is determined to be the time duration from the end of the dead time to be the next first trigger signal in the case the second trigger signal is generated within the minimum dead time, and the ON width is determined to be the time duration from the moment the second trigger is generated to the next first trigger signal in the case the second trigger signal is generated after the end of the minimum dead time.

The switching power supply in accordance with certain embodiments of the invention comprises: a differentiating circuit that differentiates a detected voltage across an auxiliary winding of the transformer after receiving a first trigger signal for turning OFF of a semiconductor switch and detects an inversion beginning timing or an inversion ending timing of the detected voltage; and a dead time adjusting circuit that generates a second trigger signal for a timing to turn ON the semiconductor switch delaying a predetermined time after the timing detected by the differentiating circuit. The switching power supply comprises a voltage controlling oscillator including an ON width determining means that comprises a minimum dead time generating circuit for generating a minimum dead time on receiving the first trigger signal and starts up operation to determine an ON width of the semiconductor switch after the minimum dead time. As a result, the switching frequency is stable even if the dead time is changed, and oscillation of the resonant frequency and unstable resonance are eliminated. Therefore, a relatively stable switching power supply can be provided.

### BRIEF DESCRIPTION OF THE DRAWINGS

FIG. 1 is a circuit diagram of a switching power supply of a first embodiment of the invention;

FIG. 2 is an example of a circuit diagram of the voltage control oscillator indicated in FIG. 1;

FIG. 3 shows operational waveforms in the switching power supply of the first embodiment;

FIG. 4 is a circuit diagram of a first conventional example of a switching power supply;

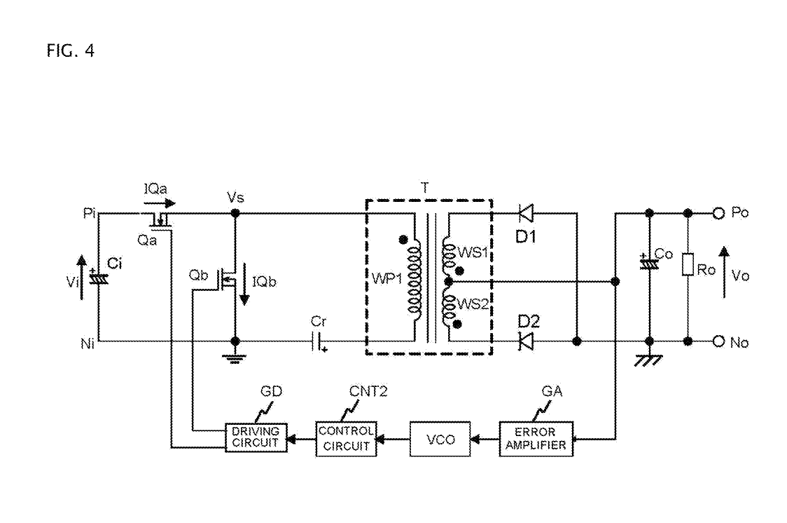

FIG. 5 is a circuit diagram of a second conventional example of a switching power supply;

FIG. 6 is a circuit diagram of a voltage control oscillator of the second conventional example of a switching power supply; and

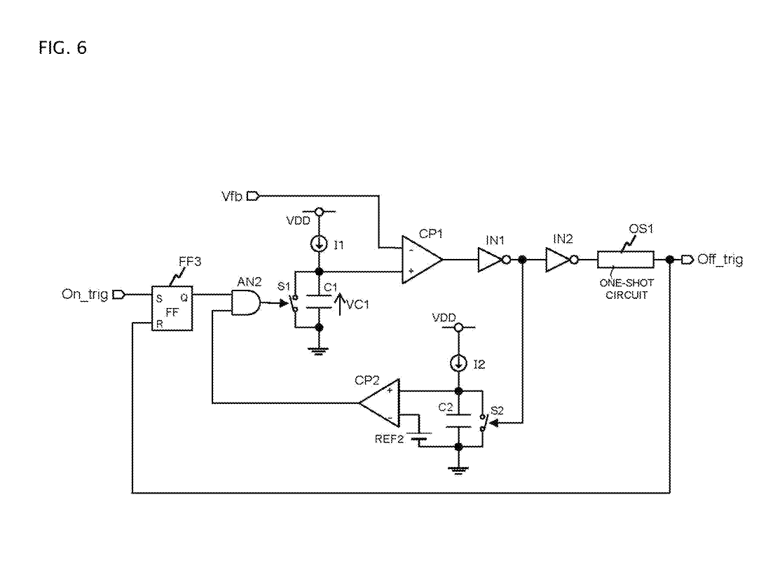

FIG. 7 shows operational waveforms in the second conventional example of a switching power supply.

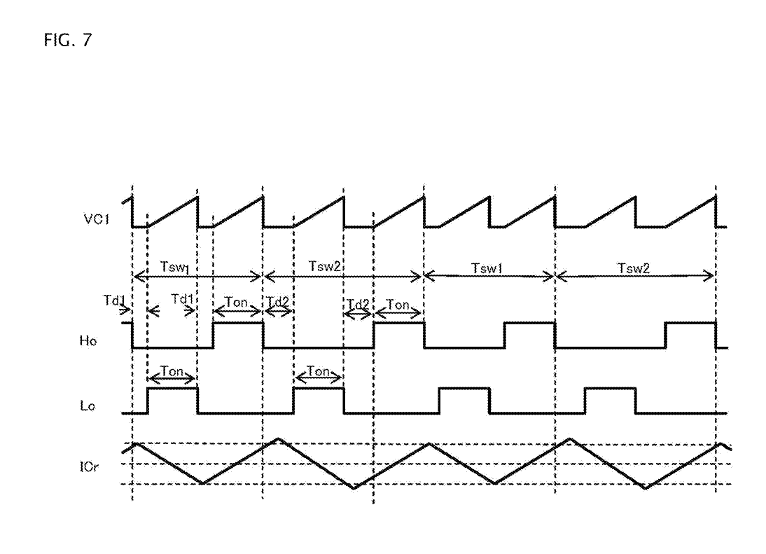

### DETAILED DESCRIPTION

A switching power supply, in accordance with certain embodiments of the invention can include: a differentiating circuit that differentiates a detected voltage across an auxiliary winding of the transformer after receiving a first trigger signal for turning OFF of a semiconductor switch and detects an inversion beginning timing or an inversion ending timing of the detected voltage; and a dead time adjusting circuit that generates a second trigger signal for a timing to turn ON the semiconductor switch delaying a predetermined time after the timing detected by the differentiating circuit. The switching power supply comprises a voltage controlling oscillator including an ON width determining means that comprises a minimum dead time generating circuit for generating a minimum dead time on receiving the first trigger signal and starts up operation to determine an ON width of the semiconductor switch after the minimum dead time.

### Embodiment

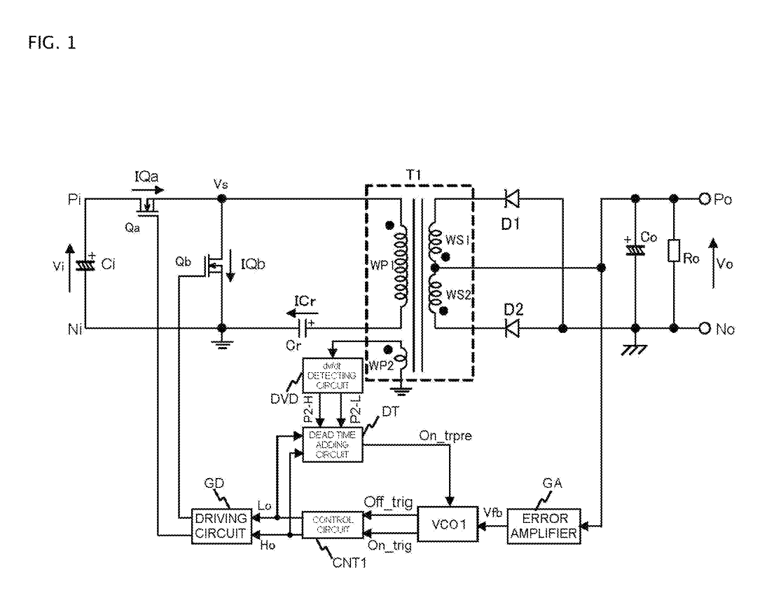

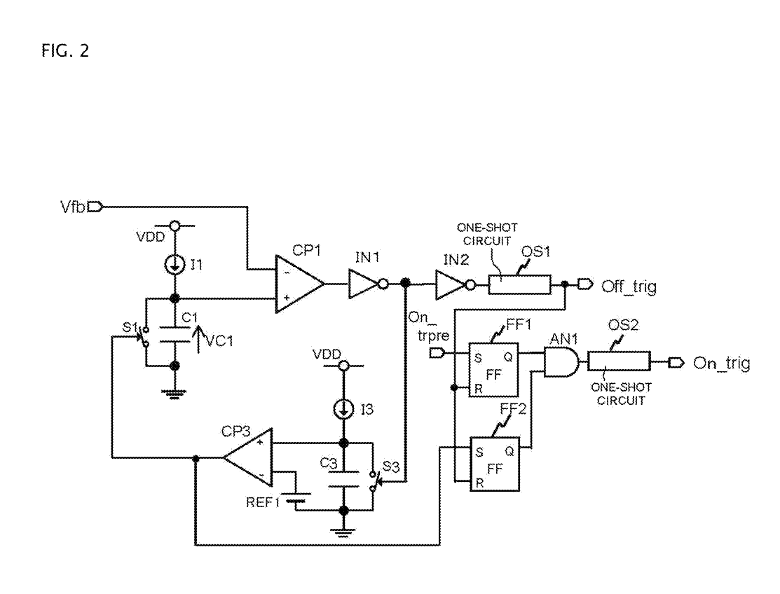

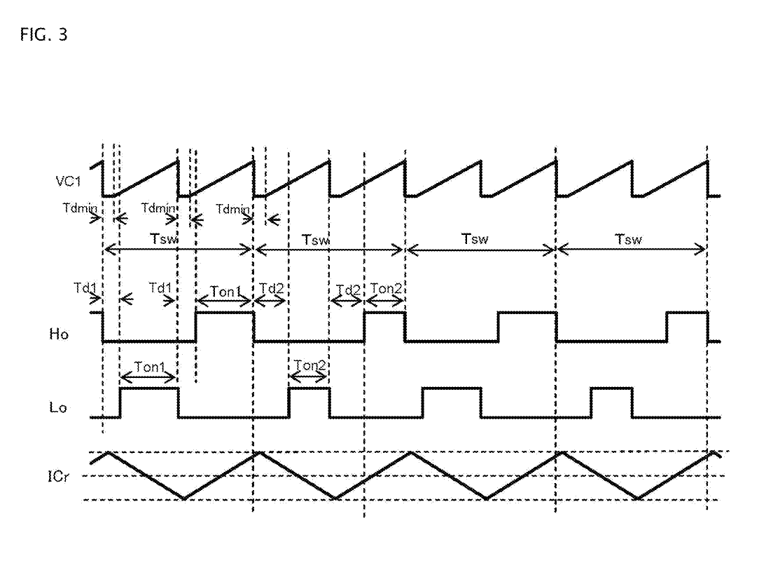

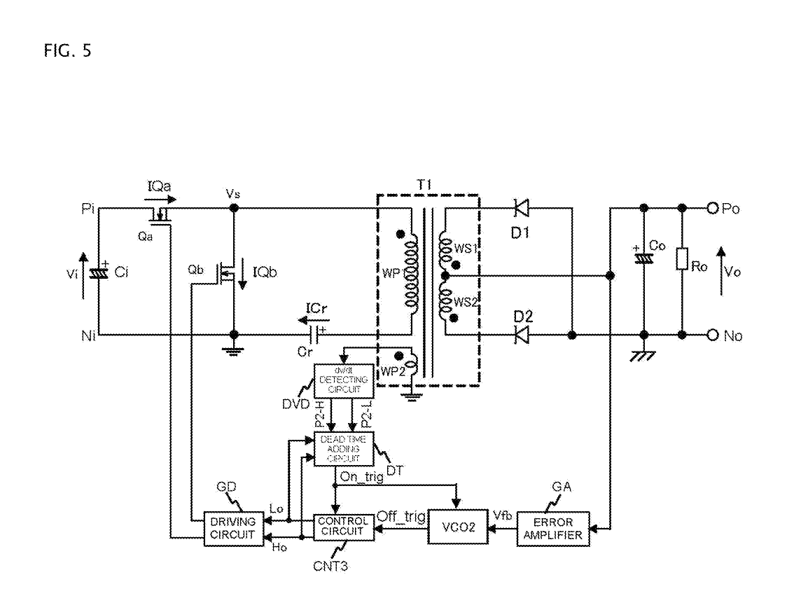

FIG. 1 shows a circuit diagram of a switching power supply of an embodiment of the invention. The switching power supply of the embodiment of FIG. 1 is different from the second conventional example of FIG. 5 in that while the output signal On_trig from the dead time adding circuit (or the dead time adjusting circuit) is delivered to the control circuit CNT3 and the voltage control oscillator VCO2 in the conventional switching power supply, an On_trpre signal from the dead time adding (adjusting) circuit DT is delivered to a voltage control oscillator VCO1, from which an Off_trig signal and an On_trig signal are given to the control circuit CNT1 in the invented switching power supply. FIG. 2 shows a detailed circuit diagram of the voltage control oscillator VCO1 of the embodiment; and FIG. 3 shows operation waveforms in the switching power supply of the embodiment.

In the detailed circuit diagram of the voltage control oscillator VCO1 shown in FIG. 2, the circuit for determining and generating the minimum dead time Tdmin comprises a capacitor C3, a current source I3, a switch S3, a comparator CP3, and a reference voltage REF1. The switch S3 is opened at the time of transition of the switching signal from an ON signal to an OFF signal to charge the capacitor C3 with the current source I3. When the voltage across the capacitor 3 reaches the reference voltage REF1, the output of the comparator CP3 turns to H (high), which opens the switch S1.

The integration circuit for determining the ON pulse width comprises a capacitor C1, a current source I1, and a switch S1. The capacitor C1 begins to be charged with the current source I1 after the minimum dead time Tdmin. A comparator CP1 compares the voltage VC1 across the capacitor C1 and the feedback voltage Vfb, which is the output of the error amplifier GA. At a time, a first trigger time, at which the voltage VC1 reaches the feedback voltage Vfb, the ON pulse turns OFF. Since the minimum dead time Tdmin can be selected at a sufficiently small value as compared with a switching time width, change of the dead time does not affect the time duration Tsw of one period, and the switching frequency does not vary as well.

A flip-flop FF1 is set by the On_trpre signal and reset by the Off_trig signal; a flip-flop-FF2 is set by the minimum dead time Tdmin and reset by the Off_trig signal. The Q output of the FF1 and the Q output of the FF2 are given to the AND gate AN1, which generates a logical product of the two Q outputs and delivers it to a one-shot circuit OS2, to obtain an On_trig.

FIG. 3 shows operational waveforms in the switching power supply of the embodiment according to the present invention. These are waveforms in the case of dead time Td1 or Td2 larger than the Tdmin. In FIG. 3, the symbol VC1 shows the waveform of the voltage of the capacitor C1; Ho, the ON/OFF signal of the high side MOSFET Qa; Lo, the ON/OFF signal of the low side MOSFET Qb; and ICr, the current through the resonance capacitor Cr. Time duration of one period Tsw is 2*(Td1+Ton1) when a dead time is Td1 and an ON pulse width is Ton1; and time duration of one period Tsw is 2*(Td2+Ton2) when a dead time is Td2 and an ON pulse width is Ton2. When the dead time increases, the ON pulse width is shortened to keep the time duration of one period unchanged. Thus the switching frequency is kept constant. The Ton1 and Ton2 are the time duration from the end of the dead time to the next first trigger signal. If the dead time Td1 or Td2 is smaller than the Tdmin, the dead time Td1 (or Td2) is equalized to the Tdmin to obtain stable operation. In this case, the time duration of one period Tsw is equal to 2*(Tdmin+Ton), where Ton is a time duration from the end of the minimum dead time to the next first trigger signal.

In the operation described above, the switching time width Tsw (or the time duration of one period) is kept at a constant value even if the dead time Td is changed, and thus, the switching frequency is constant as well.

In the embodiment described thus far, capacitors are used in the circuit for generating a dead time and a circuit for generating an ON pulse width. However, other circuit component for example, digital counter, can be used as well, as long as it performs an integrating function. In the embodiment described thus far, a resonance inductance in the main circuit is the leakage inductance of the transformer. However, a resonance reactor can be connected in series to the primary winding of the transformer to perform the same operational control.

Embodiments of the invention prevent frequency variation in the circuit for avoiding through-current and hard switching in a resonance type switching power supply using series-connected semiconductor switches. Embodiments can be applied to various types of switching power supplies and inverters for induction heating apparatuses, for example.

Examples of specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the above description, specific details are set forth in order to provide a thorough understanding of embodiments of the invention. Embodiments of the invention may be practiced without some or all of these specific details. Further, portions of different embodiments and/or drawings can be combined, as would be understood by one of skill in the art.

This application is based on, and claims priority to, Japanese Patent Application No. 2012-013710, filed on Jan. 26, 2012. The disclosure of the priority application, in its entirety, including the drawings, claims, and the specification thereof, is incorporated herein by reference.

What is claimed is:

1. A switching power supply comprising:
a transformer having a primary winding, a secondary winding, and a auxiliary winding, the auxiliary winding being disposed in a primary side of the transformer and detecting variation in a voltage across the primary winding;
a series-connected circuit including a first semiconductor switch and a second semiconductor switch, the series connected circuit being connected in parallel to a DC power source;
a series-connected resonance circuit including series-connected components of a resonance capacitor, an inductance element of at least one of a resonance reactor or a leakage inductance of the transformer, and the primary winding of the transformer;
a differentiating circuit for detecting a timing of an inversion beginning timing or an inversion ending timing of the voltage detected by the auxiliary winding after receiving a first trigger signal for turning OFF of the first semiconductor switch or the second semiconductor switch;
a dead time adjusting circuit for generating a second trigger signal at a timing of turn ON the first semiconductor switch or the second semiconductor switch delaying a predetermined time period from the timing detected by the differentiating circuit; and
a voltage control oscillator including an ON width determining means that comprises a minimum dead time-generating circuit for generating a minimum dead time on receiving the first trigger signal and starts up operation to determine an ON width of the first semiconductor switch or the second semiconductor switch after the minimum dead time.

2. The switching power supply according to claim 1, wherein,
the ON width determining means comprises: a minimum dead time-generating circuit for generating the minimum dead time on receiving the first trigger signal,
an integration circuit to start integrating operation according to an output signal of the minimum dead time generating circuit, and
a voltage comparing circuit for comparing the output of the integrating circuit with an output of an error amplifier that senses a DC output voltage and eliminates the deviation between the reference value, and wherein,
the ON width is determined to be the time duration from the end of the minimum dead time to the next first trigger signal in the case the second trigger signal is generated within the minimum dead time, and the ON width is determined to be the time duration from the moment the second trigger signal is generated to the next first trigger signal in the case the second trigger signal is generated after the end of the minimum dead time.
